(19) United States
(12) Patent Application Publication
(10) Pub. No.: US 2026/0093297 A1
(43) Pub. Date: Apr. 2, 2026

(54) MEMORY MODULE MOUNTING FRAME

(71) Applicant: SMART Modular Technologies, Inc., Newark, CA (US)

(72) Inventors: Kwang Jin Gooi, Pulau Pinang (MY); Muhammad Annuar Bin Johani, Pulau Pinang (MY); Ali Akbar Bin Abdul Aziz, Pulau Pinang (MY); Satyanarayan Iyer, Fremont, CA (US)

(21) Appl. No.: 18/904,392

(22) Filed: Oct. 2, 2024

(51) Int. Cl. G06F 1/18

(52) U.S. Cl. CPC G06F 1/185

(57) ABSTRACT

A memory module mounting frame is disclosed. In one aspect, a frame has a plurality of bays formed from sidewalls. Each sidewall includes an aperture that allows air flow therethrough. Further, at least two opposing sidewalls may include guide rail channels that assist in holding a memory module in place. The frame is made from a material that is substantially resistant to changes in size or deformation caused by heat. In particularly contemplated aspects, the frame may be made from acrylonitrile butadiene styrene (ABS) plastic, is generally rectilinear, and configured to interoperate with differential dual in-line memory modules (DDIMM). The improved rigidity of the frame helps prevent physical damage or functional failure of the DDIMM due to external shock or vibration while also allowing for improved cooling opportunities.

### BACKGROUND

### Field of the Disclosure

The technology of the disclosure relates generally to a frame to mount a memory module and, more particularly, to a mounting frame that allows improved airflow.

### Background

Computing devices abound in modern society. The prevalence of computing devices is driven, in part, by the myriad tasks that they are able to perform. However, more complex tasks require high-performance processors with ample memory available to assist in performing complex calculations at high speeds. While high-performance computers are less space-constrained than, for example, a smartphone or tablet, there are still pressures to keep the size of high-performance computers reasonable (in part to allow multiple such devices to be co-located at a single facility (e.g., a server farm)). When high-performance processors and large amounts of memory are placed in a relatively small or confined space, waste heat may be trapped in that space and potentially degrade performance. While one solution is simply to make larger spaces to contain the processors and memory, this solution is commercially impractical. Accordingly, finding ways to remove waste heat from confined spaces provides room for innovation.

### SUMMARY

Aspects disclosed in the detailed description include a memory module mounting frame. In particular, aspects of the present disclosure contemplate a frame having a plurality of bays formed from sidewalls. Each sidewall includes an aperture that allows air flow therethrough. Further, at least two opposing sidewalls may include guide rail channels that assist in holding a memory module in place. The frame is made from a material that is substantially resistant to changes in size or deformation caused by heat. In particularly contemplated aspects, the frame may be made from acrylonitrile butadiene styrene (ABS) plastic, is generally rectilinear, and configured to interoperate with differential dual in-line memory modules (DDIMM). The improved rigidity of the frame helps prevent physical damage or functional failure of the DDIMM due to external shock or vibration while also allowing for improved cooling opportunities.

In this regard, in one aspect, a memory module mounting frame is disclosed. The memory module mounting frame includes a first bay comprising a first wall comprising a guide rail configured to receive an edge of a memory module therein and an aperture configured to allow airflow along a longitudinal axis of the memory module when the edge of the memory module is positioned in the guide rail. The memory module mounting frame also includes a second wall intersecting and perpendicular to the first wall and parallel to the memory module, the second wall comprising a second aperture.

In another aspect, a method of cooling a memory module is disclosed. The method includes positioning a memory module in a frame and socket on a substrate, where positioning includes sliding an edge of the memory module into a guide rail of the frame and directing an airflow through an aperture in the frame across the memory module.

In another aspect, a computing device is disclosed. The computing device includes a substrate, a central processing unit positioned on the substrate, and a socket configured to receive a memory module on the substrate. The computing device includes a frame comprising a first bay comprising a first wall comprising a guide rail configured to receive an edge of a memory module therein and an aperture configured to allow airflow along a longitudinal axis of the memory module when the edge of the memory module is positioned in the guide rail. The computing device also includes a second wall intersecting and perpendicular to the first wall and parallel to the memory module, the second wall comprising a second aperture.

### BRIEF DESCRIPTION OF THE DRAWINGS

FIG. 1 is a front elevational view of a conventional memory module about to be inserted into a conventional socket which may be present on a motherboard or the like;

FIG. 2 is an isometric view of a memory mounting frame according to aspects of the present disclosure;

FIGS. 3A-3C provide top, side, and end views of the frame of FIG. 2;

FIG. 4 is an isometric view of the frame of FIG. 2 with a plurality of memory modules mounted therein;

FIGS. 5A-5C provide top, side, and end views of the card and frame combination of FIG. 4;

FIG. 5D is an additional isometric view of the frame of FIG. 2 with a single card highlighting the sockets into which the memory modules may be inserted;

FIG. 6A is an isometric view of a single bay frame showing horizontal airflow to cool the memory module positioned therein;

FIG. 6B is an isometric view of the single bay frame of FIG. 6A with vertical airflow to cool the memory module positioned therein;

FIG. 7 is a flowchart illustrating an exemplary process for cooling memory modules mounted in a frame according to aspects of the present disclosure; and

FIG. 8 is a block diagram of a computing device, which may include memory modules using the frames of FIGS. 2-6B according to the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a," “an,” and “the” are intended to include the plural forms as well unless the context clearly indicates otherwise. It will be further understood that the terms “comprises," “comprising," “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Additionally, to the extent that the term “approximately” is used in the claims, it is herein defined to be within five percent (5%).

Aspects disclosed in the detailed description include a memory module mounting frame. In particular, aspects of the present disclosure contemplate a frame having a plurality of bays formed from sidewalls. Each sidewall includes an aperture that allows air flow therethrough. Further, at least two opposing sidewalls may include guide rail channels that assist in holding a memory module in place. The frame is made from a material that is substantially resistant to changes in size or deformation caused by heat. In particularly contemplated aspects, the frame may be made from acrylonitrile butadiene styrene (ABS) plastic, is generally rectilinear, and configured to interoperate with differential dual in-line memory modules (DDIMM). The improved rigidity of the frame helps prevent physical damage or functional failure of the DDIMM due to external shock or vibration while also allowing for improved cooling opportunities.

While the present disclosure refers to the workpiece as a memory module, it should be appreciated that there may be other descriptive words such as memory card or add-in module.

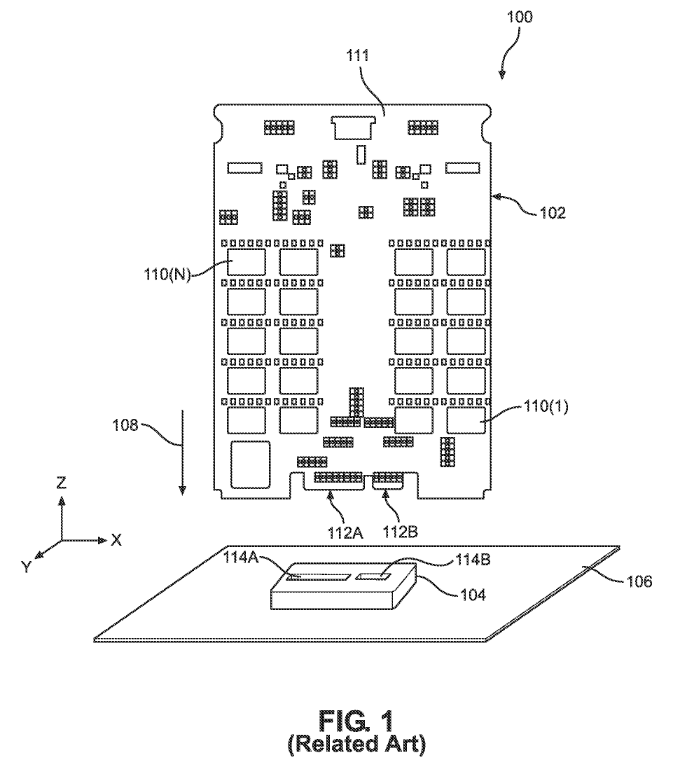

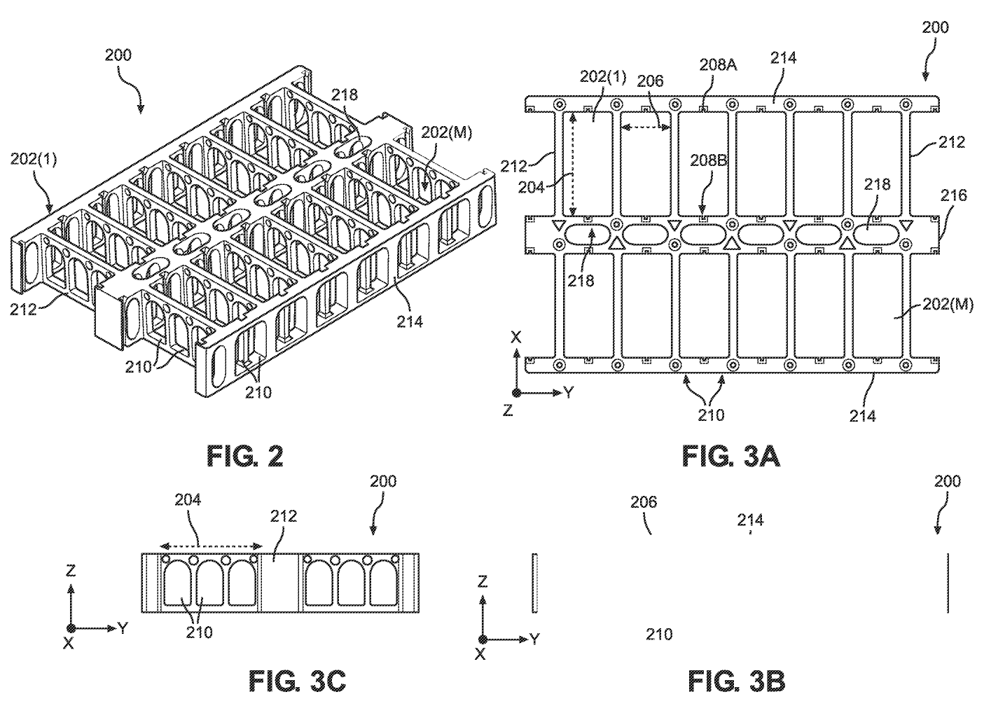

Before addressing aspects of the present disclosure, a brief overview of a memory module being used in a socket is provided with reference to FIG. 1. A discussion of aspects of the present disclosure begins below with reference to FIG. 2.

In this regard, FIG. 1 is a view of a memory system 100 having a memory module 102 about to be inserted into a socket 104 on a printed circuit board (PCB) 106 (e.g., a motherboard) or the like (see generally movement arrow 108 in the z-axis direction). The memory module 102 may include a plurality of memory modules 110(1)-110(N) as well as other circuitry (not labeled) positioned on a substrate (e.g., another PCB) 111. The memory module 102 may further include one or more (two shown) contact portions 112A, 112B that contain conductive elements and are sized to fit within slots 114A, 114B of the socket 104. While not shown, the slots 114A, 114B also have conductive elements positioned therewithin so as to allow an electrical connection between the memory module and the socket 104.

It should be appreciated the substrate may be relatively thin (in the y-axis direction) and may be variously sized in the x-z plane. As the z-axis dimension (i.e., height) increases, the stability for the memory module 102 offered by the socket 104 decreases, particularly if there is vigorous airflow introduced by fans for cooling purposes. Further, as the number of memory modules 110(1)-110(N) and other circuitry on the memory module 102 increases, the amount of waste heat generated increases, thereby increasing the need for cooling airflow. In extreme cases, the memory module 102 may come out of the socket 104 because of airflow agitation (or other mechanical action (e.g., being dropped)). When the memory module 102 exits the socket 104 in such an unintentional manner, device performance is impeded.

Various efforts to provide stabilization have been offered. However, to date, such stabilizers have proven vulnerable to mechanical deformation after exposure to the waste heat. Once deformed, such stabilizers no longer provide the desired stability and again the memory module 102 may exit the socket 104 in an undesired manner. While aspects of the present disclosure are specifically contemplated for use with differential dual inline memory modules (DDIMM) memory modules, the present disclosure is not so limited and may be used with other memory modules.

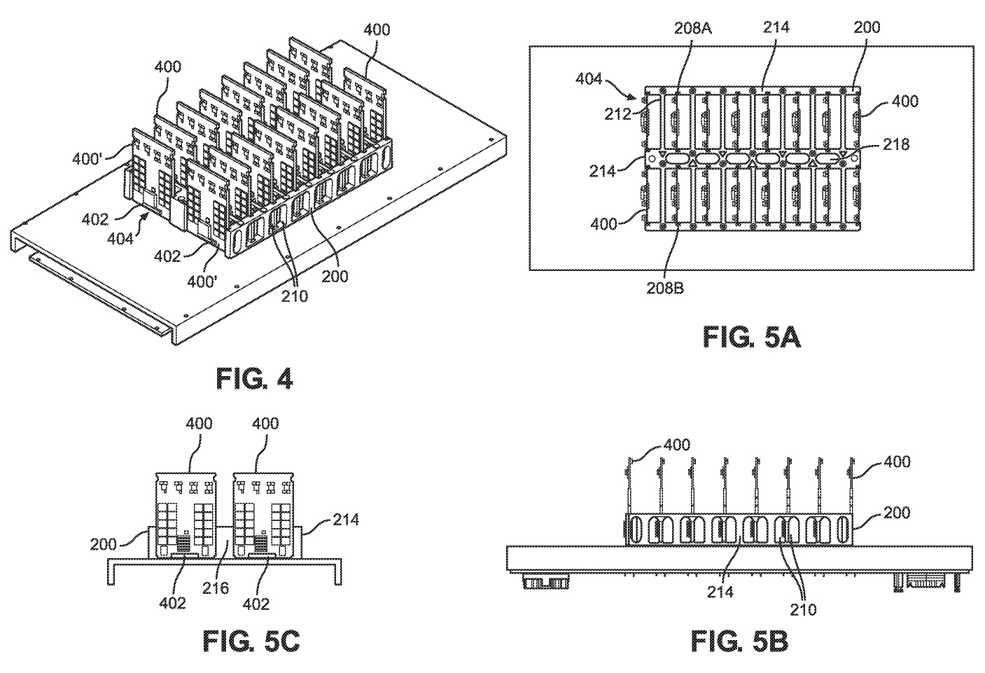

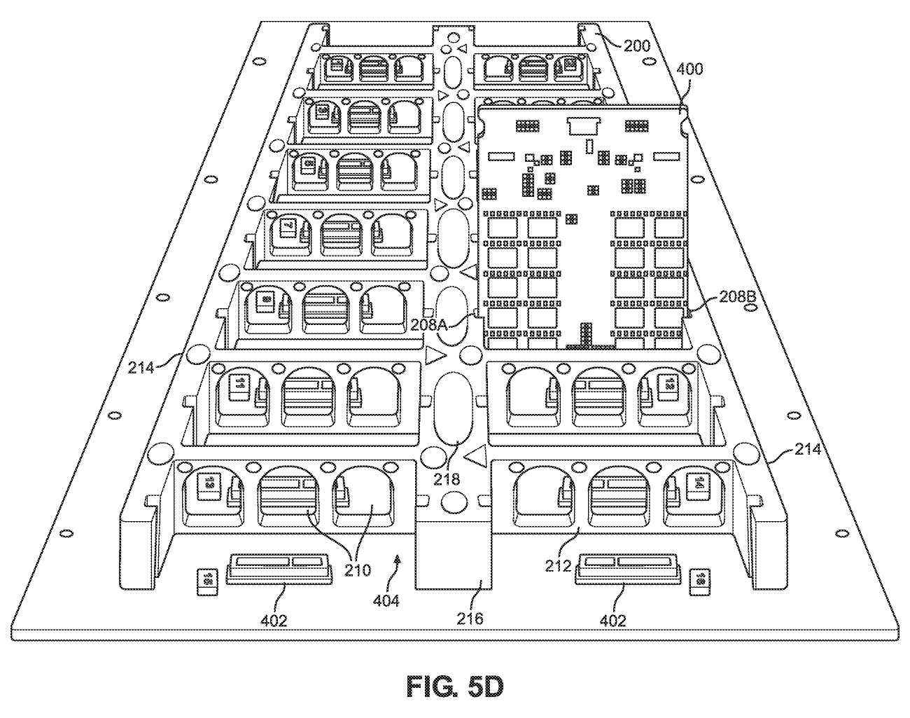

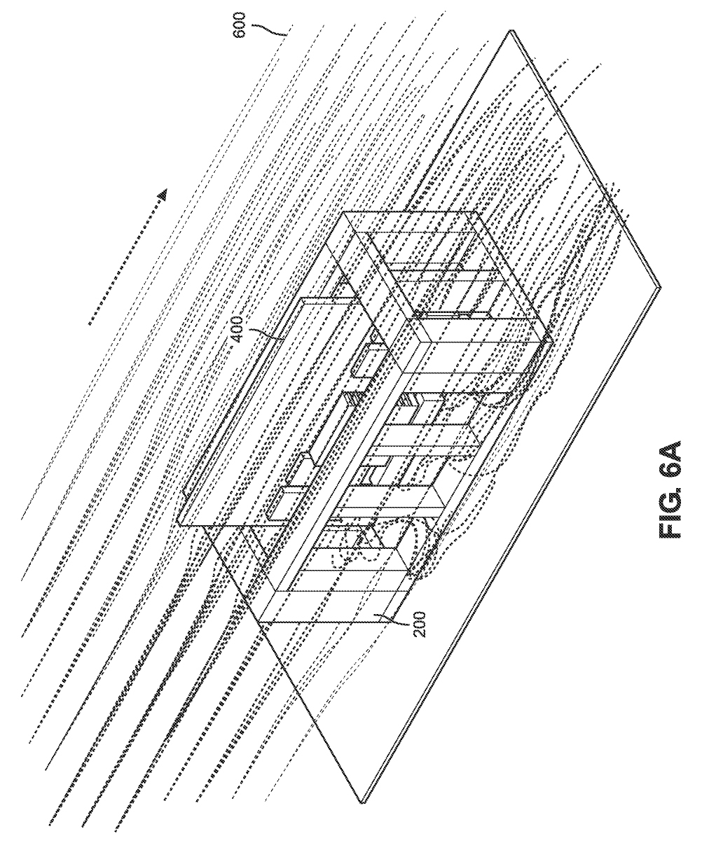

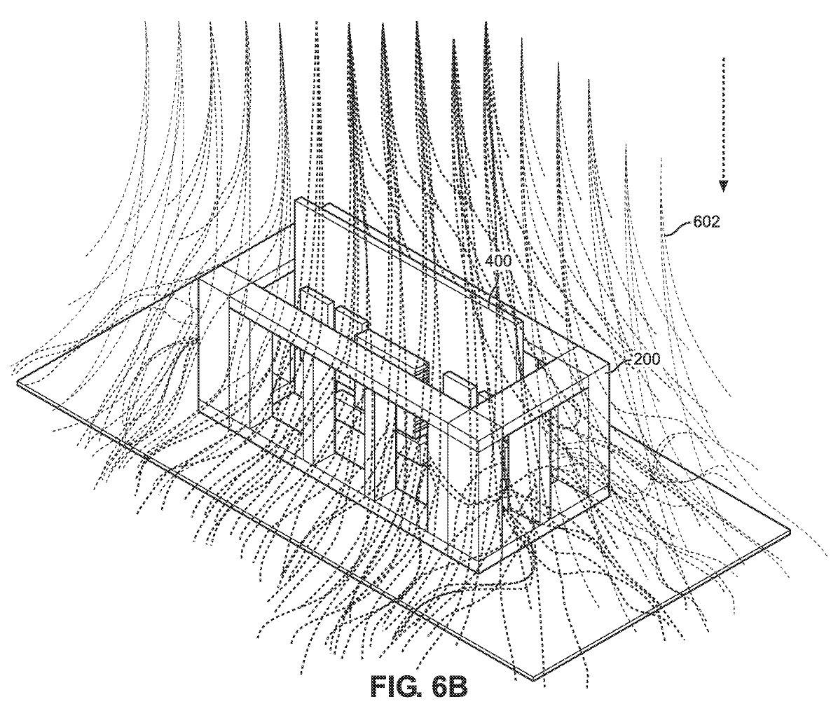

Aspects of the present disclosure introduce a frame 200 illustrated in isolation in FIGS. 2-3C and with a memory module 400 in FIGS. 4-5D. The frame 200 includes a plurality of bays 202(1)-202(M). The longitudinal dimension (x-axis) 204 of each bay 202(1)-202(M) corresponds approximately to an x-axis dimension of a memory module 400 (as better shown in FIGS. 4-5D). The lateral dimension (y-axis) 206 is sufficiently large to fit a socket 402 therein as well as allow airflow therearound (as better illustrated in FIGS. 6A & 6B). Each of the bays 202(1)-202(M) has corresponding guide rails or slots 208A, 208B. The slots 208A, 208B have a lateral dimension (y-axis) that is just slightly larger than the y-axis dimension of the memory module 400 such that the memory module 400 may slide therewithin easily, but longitudinal movement of the memory module 400 is impeded by the sidewalls of the slots 208A, 208B. To assist in air flow, windows 210 are provided in the walls of each bay 202(1)-202(M). It should be appreciated that the windows 210 are in both x-dimension walls 212 and y-dimension walls 214. In instances where there are two rows of bays 202(1)-202(M) (as illustrated), a central wall 216 may be provided with top windows 218. Windows 210 may have an arch for a top and generally linear sides and bottom, or other shapes may be used. Similarly, while window 218 is shown as oval or ellipse, other shapes may be used.

In an exemplary aspect, the frame 200 is made from ABS through an additive manufacturing process (e.g., 3D printing). ABS is known to have a deflection temperature of approximately 97° C. Typical operating temperatures are 80° C, and accordingly, the frame 200 should not suffer from deformation at operating temperatures. Other materials having a deflection temperature above approximately 85° C may also be used.

As alluded to above, FIGS. 4-5D show multiple memory modules 400 inserted into sockets 402 and supported by the frame 200. Additionally, the interoperation of the edges of the memory modules 400 and the slots 208A, 208B is better illustrated.

Note that is also possible to have partial bays 404 on end portions of the frame 200. That is, one of the longitudinal walls 212 is omitted so that a memory module 400’ is exposed or not contained within the frame 200.

The net effect of the frame 200 with memory modules 400 is improved airflow while providing additional stability. The airflow is shown in FIGS. 6A & 6B, where airflow 600 is horizontal, moving in the longitudinal direction across the memory module 400. Airflow 602 is vertical, moving in the z-axis direction. Again, the slots 208A, 208B hold the memory module 400 in place despite the agitation of the airflows 600, 602.

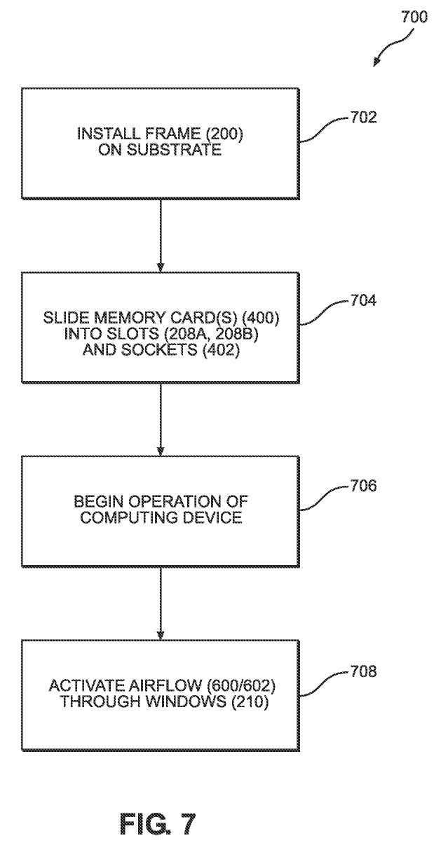

FIG. 7 is a flowchart of a process 700 for using the frame 200 with the memory modules 400 according to aspects of the present disclosure. In particular, the process 700 begins by installing the frame 200 on a substrate (block 702) such as a motherboard such as by mounting the frame 200 with screws, epoxy, or the like. Memory module(s) 400 are then slid or inserted into slots 208A, 208B, and socket(s) 402 (block 704). The computing device then begins operation (block 706), which generates waste heat. The airflows 600, 602 are then activated through windows 210 (block 708). The airflow 600, 602 may be created by fans or the like.

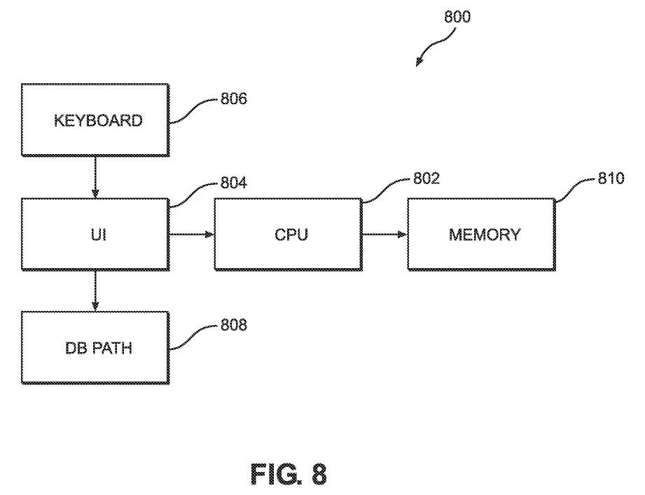

FIG. 8 illustrates a block diagram of a computing device 800 that may have the frame 200 and memory module(s) 400 therein. In particular, a central processing unit (CPU) 802 may communicate with a user interface (U/I) 804 that includes a keyboard 806 and mouse 808 (or other input/output devices). The CPU 802 may also interoperate with a memory 810 that may include memory modules 400 mounted in the frame 200 of the present disclosure.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A memory module mounting frame, comprising:
a first bay comprising a first wall comprising:
a guide rail configured to receive an edge of a memory module therein; and
an aperture configured to allow airflow along a longitudinal axis of the memory module when the edge of the memory module is positioned in the guide rail; and
a second wall intersecting and perpendicular to the first wall and parallel to the memory module, the second wall comprising a second aperture.

2. The memory module mounting frame of claim 1, further comprising:
a third wall parallel to the first wall and perpendicular to the second wall, the third wall comprising:
a second guide rail configured to receive a second edge of the memory module therein; and
a third aperture configured to allow airflow along the longitudinal axis of the memory module.

3. The memory module mounting frame of claim 2, further comprising a fourth wall intersecting and perpendicular to the first wall and the third wall and parallel to the second wall, the fourth wall comprising a fourth aperture.

4. The memory module mounting frame of claim 1, wherein the memory module mounting frame comprises an ABS material.

5. The memory module mounting frame of claim 1, wherein the memory module mounting frame comprises a material that comprises a deflection temperature above 85° C.

6. The memory module mounting frame of claim 1, further comprising a plurality of bays.

7. The memory module mounting frame of claim 6, wherein each of the plurality of bays comprises a wall with a respective guide rail and a respective aperture for airflow.

8. The memory module mounting frame of claim 7, further comprising a central wall positioned between two bays of the plurality of bays, wherein the central wall comprises a top aperture.

9. The memory module mounting frame of claim 3, wherein the first bay is sized to fit a differential dual inline memory module (DDIMM) card.

10. A method of cooling a memory module, comprising:
positioning a memory module in a frame and socket on a substrate, where positioning includes sliding an edge of the memory module into a guide rail of the frame; and
directing an airflow through an aperture in the frame across the memory module.

11. A computing device
a substrate;
a central processing unit positioned on the substrate;
a socket configured to receive a memory module on the substrate;
a frame comprising:
a first bay comprising a first wall comprising:
a guide rail configured to receive an edge of a memory module therein; and
an aperture configured to allow airflow along a longitudinal axis of the memory module when the edge of the memory module is positioned in the guide rail; and
a second wall intersecting and perpendicular to the first wall and parallel to the memory module, the second wall comprising a second aperture.

12. The computing device of claim 11, further comprising:
a third wall parallel to the first wall and perpendicular to the second wall, the third wall comprising:
a second guide rail configured to receive a second edge of the memory module therein; and
a third aperture configured to allow airflow along the longitudinal axis of the memory module.

13. The computing device of claim 12, further comprising a fourth wall intersecting and perpendicular to the first wall and the third wall and parallel to the second wall, the fourth wall comprising a fourth aperture.

14. The computing device of claim 11, wherein the frame comprises an ABS material.

15. The computing device of claim 11, wherein the frame comprises a material that comprises a deflection temperature above 85° C.

16. The computing device of claim 11, further comprising a plurality of bays.

17. The computing device of claim 16, wherein each of the plurality of bays comprises a wall with a respective guide rail and a respective aperture for airflow.

18. The computing device of claim 17, further comprising a central wall positioned between two bays of the plurality of bays, wherein the central wall comprises a top aperture.

19. The computing device of claim 13, wherein the first bay is sized to fit a differential dual inline memory module (DDIMM) card.

20. An add-in card mounting frame, comprising:
a first bay comprising a first wall comprising:
a guide rail configured to receive an edge of an add-in card therein; and
an aperture configured to allow airflow along a longitudinal axis of the add-in card when the edge of the add-in card is positioned in the guide rail; and
a second wall intersecting and perpendicular to the first wall and parallel to the add-in card, the second wall comprising a second aperture.
